(19) United States
(12) Patent Application Publication
(10) Pub. No.: US 2016/0271930 A1
(43) Pub. Date: Sep. 22, 2016

(54) STRIPPABLE FILM ASSEMBLY AND COATING FOR DRAG REDUCTION

(71) Applicant: PRC-DESOTO INTERNATIONAL, INC., SYLMAR, CA (US)

(72) Inventors: Todd M. Roper, Valencia, PA (US); Mark P. Bowman, New Kensington, PA (US); Edward F. Rakiewicz, Gibsonia, PA (US)

(21) Appl. No.: 15/065,175

(22) Filed: Mar. 9, 2016

Related U.S. Application Data
(63) Continuation of application No. 13/844,384, filed on Mar. 15, 2013, now abandoned.

(51) Int. Cl. B32B 43/00; B64C 21/10

(52) U.S. Cl. CPC B32B 43/006; B64C 21/10; B32B 2605/00

(57) ABSTRACT

An assembly includes a substrate, a film on the substrate, and a coating on the film. The film includes a material permeable to organic solvents, and the coating includes a material reactive with the film. Alternatively, the assembly may include a substrate including a textured region, and a coating on the textured region. The coating mimics the texture of the textured. In an alternative embodiment, a laminate includes a film including a material permeable to organic solvents, a coating on the film, and an adhesive on a second surface of the film. The coating includes a material reactive with the film. In another embodiment, a method for reducing drag on a substrate includes applying a film on a substrate, and applying a coating on the film. The film includes a material permeable to organic solvents, and the coating includes a material reactive with the film.

### CROSS-REFERENCE TO RELATED APPLICATIONS

This is a continuation of U.S. patent application Ser. No. 13/844,384, filed on Mar. 15, 2013, incorporated herein by reference.

### FIELD OF THE INVENTION

The present disclosure is related to strippable film assemblies for drag reduction, and to methods of making and using such film assemblies. The present disclosure is also related to an assembly including a coating on a microstructured substrate.

### BACKGROUND INFORMATION

Moving through a fluid at a high speed, objects such as aircraft, watercraft and automobiles experience significant drag resistance that acts opposite to the direction of movement. Drag resistance is often called air resistance or fluid resistance. The amount of the drag force experienced by an object is proportional to the cross-sectional area of the object in a plane perpendicular to the direction of motion, the square of the speed of the object relative to the fluid, the density of the fluid, and a drag coefficient. The drag coefficient is a variable that is dependent on the shape of the object and the Reynolds number, which is proportional to the ratio of the speed of the object relative to the fluid divided by the kinematic viscosity of the fluid. At high velocity, i.e., high Reynolds number, drag will increase as the square of velocity and the power needed to overcome this drag will vary as the cube of the velocity. In other words, the faster an object moves through a fluid, the greater the drag force will be and the more power will be needed to overcome the drag. Therefore, drag reduction has been an active research area in recent decades for aircrafts and other vehicles. The effort has been further fueled in recent years with the drive for better fuel economy.

Among various technologies for drag reduction, many focus on alternating the drag coefficient of the object through specifically developed chemical formulations or specifically designed features, referred to as aerodynamic features. The goal is to modify the turbulent boundary layer developed during the high speed movement.

Microstructures, commonly referred to as “riblets”, have been used as aerodynamic features on aerodynamic surfaces for the purpose of drag reduction. Such microstructures can significantly reduce fuel consumption and improve performance in a variety of applications, such as aircraft, water craft, wind power turbines, rail vehicles, automobiles, and pipelines. Indeed, reducing drag by just a few percent can lead to significant savings. For example, a 1% reduction in drag on a jet airliner in cruise conditions would lead to about a 0.75% reduction in fuel consumption.

Microstructures are typically imparted to an aerodynamic surface by application of a microstructured film to the surface. To date, however, the textured films used to create drag reduction do not have the chemical and physical properties necessary to hold up under the harsh conditions of flight. For example, a surface of an aerospace vehicle must be chemically inert, and have good UV stability and temperature stability. Unfortunately, the polymer films currently used to create a textured surface for drag reduction lack one or more of these properties. Consequently, even if these films can create a drag reduction surface, they must be replaced often, e.g. after one or two years of service.

As the films are only serviceable for a short time (e.g. 1 to 2 years), labor and material costs in the removal of the old film and application of a new film are quite high. Moreover, current drag reduction films are difficult to remove from the substrate. In particular, the materials currently used to create drag reduction surfaces are generally impermeable to conventional stripping solvents, and thus must be physically, rather than chemically, removed from the substrate.

### SUMMARY OF THE INVENTION

According to embodiments of the present invention, an assembly includes a substrate, a film affixed to at least a portion of the substrate, and a coating (A) on at least a portion of the film. The film includes a material that is permeable to organic solvents, and the coating (A) may include a material reactive with the material of the film. The film may include a film substrate and a coating (B) on the film substrate, and the coating (B) on the film substrate may include hydroxyl functionality, amine functionality, thiol functionality, and/or isocyanate functionality. The film substrate may include a fluoropolymer, a polyetheretherketone (PEEK), a polyester, a polyphenylsulfone, a polyolefin, a polycarbonate, and/or an acrylic film. The film is textured and the coating (A) telegraphs the texture to the external surface of the coating (A). The film and the coating (A) may be textured to include a riblet structure, a sawtooth pattern, a scalloped pattern, a blade pattern, or a combination thereof. The substrate may be an aircraft, an airplane, an automobile, a ship, a boat, a wind turbine, a water craft, an airfoil, or a rudder. The film and coating (A) may be strippable. The coating (A) may be a polyurethane based coating. The coating (A) may be formed from a coating composition having a viscosity of about 5 to about 60 seconds as measured with a #4 Ford cup.

According to other embodiments of the present invention, an assembly includes a substrate including a textured region having a texture, and a coating (A) on at least a portion of the textured region of the substrate. The coating (A) telegraphs the texture of the textured region to an exterior surface of the coating (A). The texture of the textured region of the substrate may include a riblet structure, a sawtooth pattern, a scalloped pattern, a blade pattern, or a combination thereof. The substrate may be an aircraft, an airplane, an automobile, a ship, a boat, a wind turbine, a water craft, an airfoil, or a rudder. The coating (A) may be a polyurethane based coating. The coating (A) may be formed from a coating composition having a viscosity of about 5 to about 60 seconds as measured with a #4 Ford cup.

In yet other embodiments, a laminate includes a film including a material that is permeable to organic solvents, a coating (A) on at least a portion of a first surface of the film, and an adhesive on a second surface of the film. The coating (A) includes a material reactive with the material of the film. The laminate may also include a release liner on the adhesive. The film may include a film substrate and a coating (B) on the film substrate, and the coating (B) on the film substrate may include hydroxyl functionality, amine functionality, thiol functionality, and/or isocyanate functionality. The film substrate may include a fluoropolymer, a polyetheretherketone (PEEK), a polyester, a polyphenylsulfone, a polyolefin, a polycarbonate, and/or an acrylic film. The film may be textured and the coating (A) may telegraph the texture to an exterior surface of the coating (A). The film and the coating (A) may be textured to include a riblet structure, a sawtooth pattern, a scalloped pattern, a blade pattern, or a combination thereof.

According to other embodiments of the present invention, a method for reducing drag on a substrate includes applying a film on at least a portion of a substrate, and applying a coating (A) on at least a portion of the film. The film includes a material that is permeable to organic solvents, and the coating (A) may include a material reactive with the material of the film. The film may include a film substrate and a coating (B) on the film substrate, and the coating (B) on the film substrate may include hydroxyl functionality, amine functionality, thiol functionality, and/or isocyanate functionality. The film substrate may include a fluoropolymer, a polyetheretherketone (PEEK), a polyester, a polyphenylsulfone, a polyolefin, a polycarbonate, and/or an acrylic film. The film may be textured, and upon applying the coating (A) to the film, the coating (A) may be textured. The film may be textured to include a riblet structure, a sawtooth pattern, a scalloped pattern, a blade pattern, or a combination thereof. The coating (A) may be a polyurethane based coating. The coating (A) may be formed from a coating composition having a viscosity of about 5 to about 60 seconds as measured with a #4 Ford cup.

### BRIEF DESCRIPTION OF THE DRAWINGS

These and other features and advantages of the present invention will be better understood by reference to the following detailed description when considered in conjunction with the following drawings, in which:

FIG. 1 is a cross-sectional view of one embodiment of a film assembly;

FIG. 2a is a cross-sectional schematic view of an exemplary embodiment of a film assembly applied onto a substrate;

FIG. 2b is a cross-sectional schematic view of another exemplary embodiment of a film assembly applied onto a substrate;

FIG. 2c is a cross-sectional schematic view of a coating layer over a microstructured substrate;

FIG. 2d is a partial cross-sectional schematic view of a laminate according to an embodiment of the present invention;

FIG. 3a is a top view of an exemplary structured film on a substrate;

FIG. 3b is a schematic illustration of one embodiment of the riblet structure;

FIG. 3c is a schematic illustration of another embodiment of the riblet structure;

FIGS. 4a and 4b are graphs representing the surface profile of the microstructured film of Example 1 before (4a) and after (4b) being coated;

FIGS. 5a and 5b are photographs of the microstructured film of Example 1 before (5a) and after (5b) being coated;

FIG. 6 is a graph comparing the surface profile of the microstructured film of Example 2 before coating and after coating at two different thicknesses; And

FIG. 7 is a graph comparing the surface profile of the microstructured film of Example 3 before coating and after coating at two different thicknesses.

### DETAILED DESCRIPTION

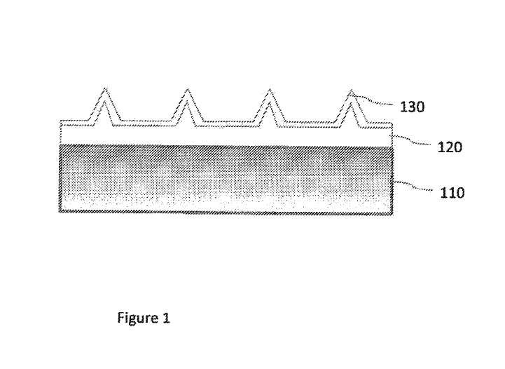

Referring to FIG. 1, in embodiments of the present invention, a drag reduction assembly includes a substrate 110, a film 120 affixed to at least a portion of the substrate, and a coating (A) 130 on at least a portion of the film. The film 120 includes a material that is permeable to organic solvents, and the coating (A) 130 includes a material that is reactive with the material of the film. In some embodiments of the invention, the film is textured with microstructures, and the coating (A) conforms to the texture of the film such that the profile of the textured film reads through to the surface of the coating. The assemblies according to the present invention provide drag reduction when used on high speed vehicles, such as aircraft, water craft, wind turbines, and automobiles. As used herein, the phrases “telegraphs the texture of the film,” “mimics the texture of the film,” “reads the profile of the film through to the surface of the coating (A),” and similar phrases are all used to denote that the coating (A) takes on and faithfully reproduces the texture of the underlying film such that the external surface of the coating faithfully reproduces the texture of the film.

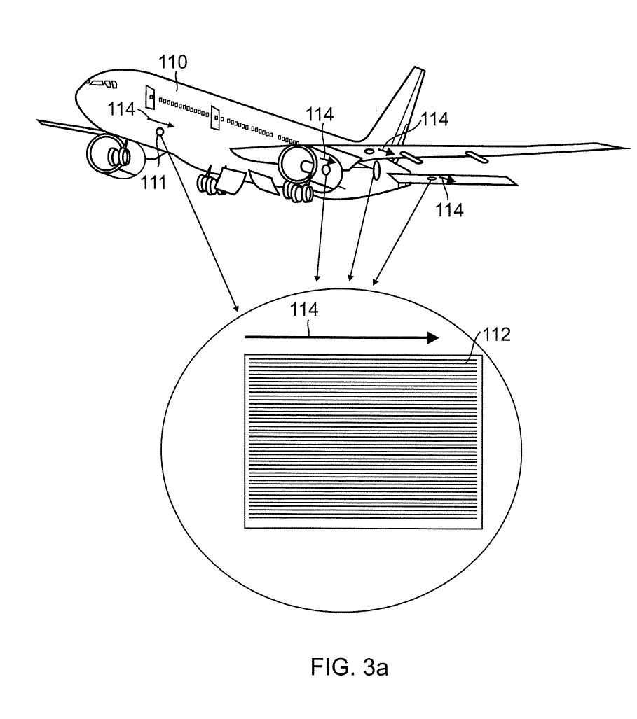

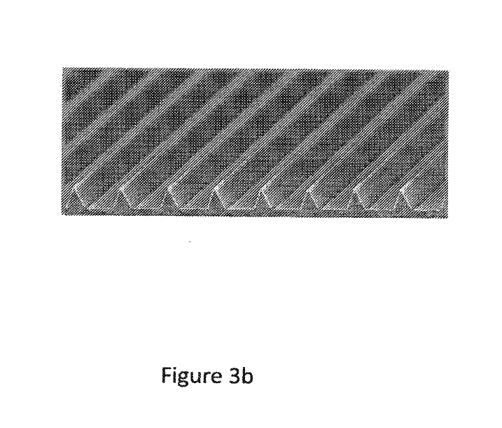

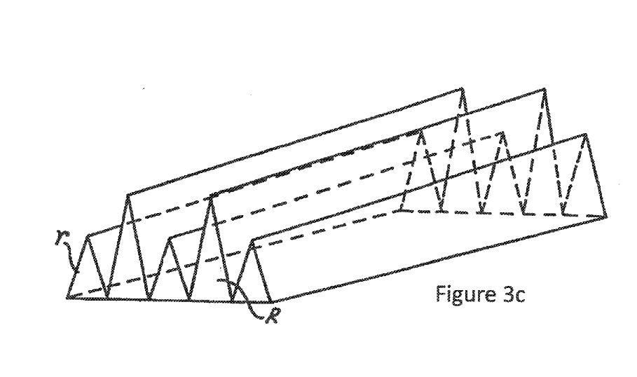

The microstructures in the film can take any suitable shape, e.g., a riblet structure, a sawtooth pattern, a scalloped pattern, a blade pattern or a combination thereof. In one embodiment, for example, the microstructures may be as depicted in FIG. 3a, which shows a riblet structure aligned to the direction of flight on certain parts of an airplane. In another embodiment, the riblet structure has generally triangular shaped projections spaced apart by valleys between the projections, as shown in FIG. 3b. In another embodiment, instead of having a sharp peak, the microstructures have generally trapezoidal projections. Although described and depicted here as generally triangular or generally trapezoidal, the projections may have any suitable shape, additional examples of which include notched-peaks, sinusoidal projections and U-shaped riblets. In embodiments of the present invention, the microstructures may include a series of differently sized riblet projections arranged in a pattern. For example, the projections may include a number of spaced apart larger projections, between which are positioned a plurality of spaced apart smaller projections, as shown in FIG. 3c.

The projections may have, e.g., a V-shaped profile, and the valleys between adjacent projections may be concavely curved. The height of each projection may be non-uniform along the length of the projection (i.e., the length of the surface in the direction of movement). The spacing between adjacent projections can be from tens of microns up to about a few millimeters. The height of the projections can be from tens of microns to a few millimeters. In one exemplary embodiment, the riblets are about 25 microns in height and about 50 microns apart. In one embodiment of the invention, the riblet structure (as shown in FIG. 3b) has triangular projections with a height of about 75 microns, and a spacing between adjacent peaks of about 150 microns. Although certain exemplary shapes and structures of the projections or riblets are described, it is understood that the projections or riblets can take any suitable shape and/or structure. The shape and structure of some exemplary microstructures are described generally in U.S. Pat. Nos. 4,930,729, 5,386,955, and 5,542,630 (all of which are titled “Control of Fluid Flow” and issued to A. M. Savill on Jun. 5, 1990, Feb. 7, 1995 and Aug. 6, 1996, respectively), and U.S. patent application Ser. No. 12/566,907 (published as U.S. 2011/0073710 A1) by D. C. Rawlings et al. and titled “Structurally Designed Aerodynamic Riblets,” the entire contents of all of which are incorporated herein by reference.

The film 120 may be any suitable material. In some embodiments, for example, the film 120 includes a film substrate coated with a material that has reactive functionality, e.g. hydroxyl functionality, amine functionality, thiol functionality and isocyanate functionality. In some embodiments, the coating (b) on the film substrate is made from a curable coating formulation that includes such a reactive functionality. For example, the curable coating formulation may include acrylated oligomers (e.g., urethane acrylates, polyester acrylates, acrylic acrylates or epoxy acrylates), monofunctional monomers, and/or multifunctional monomers having reactive functionality. Exemplary materials that have hydroxyl functionality include polyfunctional compounds such as glycols, triols, tetraols, polyester polyols, polyether polyols, acrylic polyols, and polylactone polyols. Some exemplary coating systems for the coating (B) on the film substrate include polyurethanes, polyesters, epoxies, etc. As noted above, the reactive functionality may include hydroxyl functionality, amine functionality, thiol functionality and/or isocyanate functionality. For example, the coating (B) on the film substrate may be made from a urethane acrylate system having excess hydroxyl. Both the film substrate and the coating (B) on the film substrate may also include other additive ingredients for developing specific end properties, such as pigments, colorants, fillers, plasticizers, etc.

The film substrate (on which the curable composition is coated), may be provided in web form, and may be paper- or polymer-based. Some nonlimiting examples of suitable polymer-based film substrates include polyester films, fluorinated polymer films, polycarbonate films, etc. For example, in some embodiments, the film substrate may be selected from fluoropolymers, polyetheretherketone (PEEK), polyesters, polyphenylsulfone, polyolefins, polycarbonates, and acrylic films. Exemplary film materials (which include the film substrate and the coating on the film) include ULTRACAST®, ULTRACAST® STRATUM®, and ADVA®, manufactured by Sappi-Warren Release Papers (S. D. Warren Company d/b/a Sappi Fine Paper North America) in Westbrook, Me. ULTRACAST®, ULTRACAST® STRATUM®, and ADVA® are registered trademarks of S. D. Warren Company.

The microstructured texture can be imparted to the film by any suitable technique, such as micro-replication, embossing, chemical etching or laser patterning. In one exemplary embodiment, the texture on the film may be formed by a method that includes coating a curable composition onto a film substrate, imparting a pattern via an engraved roll, curing the curable composition via, e.g., radiation, and removing the cured film substrate from the engraved roll, resulting in substantially 100% replication of the engraved pattern. The film substrate (on which the curable composition is coated), may be provided in web form, and may be paper- or polymer-based.

The coating (A) 130 may be any coating capable of conforming to the texture of the film and telegraphing the texture of the film through to the surface of the coating (A) (i.e., a coating capable achieving profile read through of the texture of the underlying film). For example, in some embodiments of the invention, the coating (A) is a polyurethane based material made from the reaction of hydroxyl functional polyols and organic polyisocyanates. Suitable polyurethane coatings include two-part coating compositions, but the present invention is not limited thereto. A typical two-part composition includes a base component and an activator component. The activator component includes compounds with isocyanate functionality, and the base component includes compounds with hydroxyl functionality. The base and activator components are mixed just prior to application of the coating (A). Upon being mixed and coated onto a substrate, the coating formulation cures as the isocyanate groups in the activator component react with the hydroxyl groups in the base component, yielding the polyurethane coating. The mixture may have a pot life of up to 8 hours under agitation, and the coated film may dry cure in air at ambient condition in about 4 hours when the coating thickness is about 1.5-3 mil. The film may cure completely in about 7 days.

Some nonlimiting examples of suitable polyurethane coatings are described in U.S. Pat. No. 4,134,873 to F. A. Diaz and A. F. Leo, issued on Jan. 16, 1979, and titled “Polyurethane Topcoat Composition,” the entire content of which is incorporated herein by reference. Other nonlimiting examples of suitable polyurethane coatings are described in U.S. Pat. No. 4,341,689 to J. K. Doshi and S. A. Wallenberg, issued on Jul. 27, 1982, and titled “Two Component Polyurethane Coating System Flaying Extended Pot Life and Rapid Cure,” the entire content of which is incorporated herein by reference. Nonlimiting examples of commercially available coatings include those sold under the trade name Desothane™ by PPG Industries, Inc. Some exemplary coatings that are suitable for use in the coating (A) according to embodiments of the present invention are described in U.S. Patent Publication No. 2009/0068366 to Aklian, et al., published on Mar. 12, 2009 and titled POLYURETHANE COATINGS WITH IMPROVED INTERLAYER ADHESION, the entire content of which is incorporated herein by reference, and U.S. Pat. No. 8,383,719 to Abrami, et al., issued on Feb. 26, 2013 and titled WATER-BORNE POLYURETHANE COMINGS, the entire content of which is incorporated herein by reference.

The coating composition may further include conventional additives for coating compositions, such as catalysts, pigments, fillers, UV absorbers, flow aids, and rheology control agents. Catalysts promote the curing reaction and may be tertiary amines, metal compound catalysts, or combinations thereof. Nonlimiting examples of suitable tertiary amine catalysts include triethylamine, N-methylmorpholine, triethylenediamine, pyridine, picoline, and the like. Nonlimiting examples of suitable metal compound catalysts include compounds of lead, zinc, cobalt, titanate, iron, copper, and tin. For example, the metal compound catalyst may be lead 2-ethylhexoate, zinc 2-ethylhexoate, cobalt naphthenate, tetraisopropyl titanate, iron naphthenate, copper naphthenate, dibutyl tin diacetate, dibutyl tin dioctate, dibutyl tin dilaurate, and the like.

When used, the catalyst is present in a total amount ranging from about 0.001 to 0.05 weight percent based on the total weight of the resin solids in the coating composition. For example, the catalyst may be present in an amount ranging from about 0.005 to 0.02 weight percent based on the total weight of the resin solids in the coating composition.

The term “pigment” includes fillers and extenders as well as conventional pigments. Pigments are particulate materials which impart color or opacity to the final coating composition. Extenders and fillers are usually inorganic materials which can be used to reduce the cost of a formulation or to modify its properties. Nonlimiting examples of suitable pigments include carbon black, titanium dioxide, magnesium sulfate, calcium carbonate, ferric oxide, aluminum silicate, barium sulfate, and color pigments. When used, the pigments can be present in an amount ranging from about 10 to 50 weight percent based on the total solids weight of the coating composition. For example, the pigments and fillers may be present in an amount ranging from about 20 to 40 weight percent based on the total solids weight of the coating composition.

Rheology modifiers refer to compounds that can modify the flow and leveling properties of the coating formulation. The coating formulation should have suitable flow and leveling characteristics such that it can be coated uniformly over the surface of the micro structured film, and telegraph the microstructure of the film so that the dried coating has a surface structure that mimics the microstructure of the film, i.e., the coating (A) becomes textured as a result of being coated onto the textured film. Also, the coating composition used to form the coating (A) may have a viscosity of about 5 to about 60 seconds as measured with a #4 Ford cup. In some embodiments, for example, the viscosity may be about 20 to about 45 seconds, or about 30 to about 35 seconds as measured with a #4 Ford cup. Alternatively, the viscosity of the coating composition used to make the coating may be about 10 to about 50 seconds as measured using a #2 Zahn cup. In some embodiments, for example, the viscosity may be about 15 to about 240 seconds, or about 17 to about 30 seconds as measured using a #2 Zahn cup. The coating can be adjusted in any way to suit the needs of the user, such as by adjusting rheology, viscosity, surface tension, level of functionality and the like. These adjustments can be made, for example, by adjusting the resin molecular weight, solvent composition, coating formulation solids, application process, coating film thickness, coating reactivity, pigment composition and concentration, and rheological flow additive composition and concentration.

The coating (A) can be applied using any suitable coating method, such as spray coating, gravure coating, die coating, dip coating, or printing. The coating (A) can have any suitable dry film thickness, such as from about 5 μm to about 500 μm. However, the dry film thickness of the coating (A) will be limited by the ability to mimic the structure of the underlying film. In particular, if the coating thickness is too great, the coating (A) may lose the ability to telegraph the pattern of the underlying film. The coating formulation can be cured using any suitable technique, such as heat, UV, or NIR (near infrared radiation).

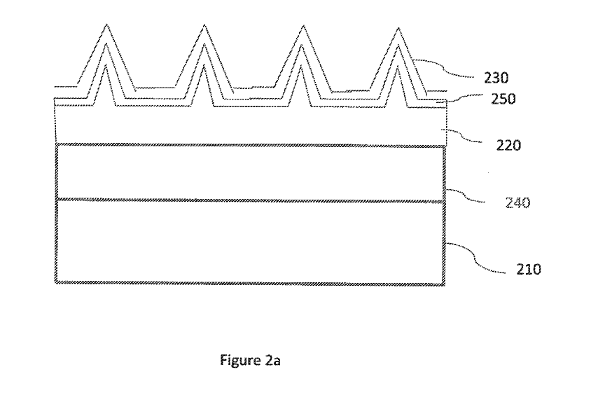

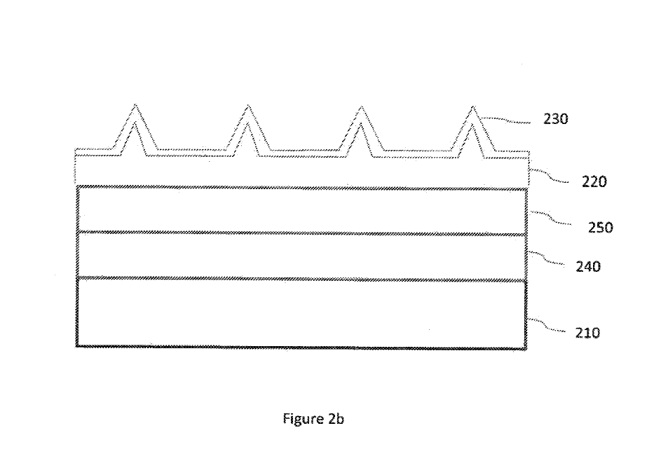

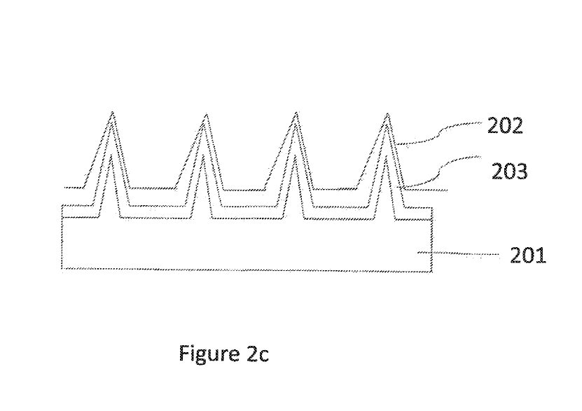

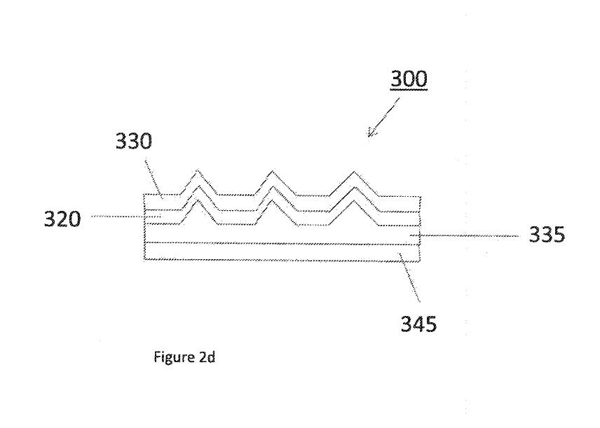

FIGS. 2a and 2b are partial cross-sectional views of two exemplary embodiments of the film assembly applied on a substrate. Referring to FIGS. 2a and 2b, the substrate 210 can be coated with one or more of a pretreatment layer 240, a primer layer 250 and a coating layer 230, and the film 220 can be located either between the pretreatment layer 240 and the primer layer 250 as shown in FIG. 2a, or between the primer layer 250 and the coating layer 230, as shown in FIG. 2b. Additionally, in some embodiments, the pretreatment layer 240 may be omitted and the primer layer 250 may be coated directly on the substrate 210 with the film 220 on the primer layer 250.

The basecoat and topcoat can be any suitable material, as described above with respect to the coating layer 130. The primer layer improves adhesion of subsequent layers to the substrate, and further protects the substrate from corrosion. For the primer composition, when applied on a non-textured substrate as shown in FIG. 2b, the rheology and other properties are not particularly limited, and the primer can be any suitable primer, which would be discernible by those of ordinary skill in the art. Some examples of suitable primers are described in U.S. Pat. No. 4,075,153 to A. F. Leo, issued on Feb. 21, 1978 and titled “Corrosion-Resistant Epoxy-Amine Chromate-Containing Primers,” the entire content of which is incorporated herein by reference.

However, when the primer coating is applied over the textured film (or over a textured substrate as described below), the primer, as well as the basecoat and/or topcoat must have the appropriate rheology (e.g., flow and leveling characteristics) to telegraph the pattern of the textured substrate through to the surface of the cured coating. In particular, the primer, basecoat and/or topcoat all must be capable of telegraphing the pattern of the underlying textured substrate.

The film assembly can be applied onto a substrate to provide drag reduction. The substrate may be any substrate, such as a surface of an aircraft, water craft, or automobile. For example, the film assembly can be applied on the surface of an airplane, a ship, a boat, a wind turbine, an airfoil, or a rudder. Also, the film assembly need not be applied to the entire surface of the vehicle to impart appreciable drag reduction. Instead, application of the film assembly in strategic locations on the vehicle will suffice to impart the desired drag-reduction. As used herein, the term “vehicle” is used broadly to refer to any moving device, including aerospace vehicles (e.g., aircraft, etc.), water vehicles (e.g., boats, ships, etc.) and motor vehicles (e.g., automobiles). The textured film assemblies according to embodiments of the present invention can reduce drag by about 1-3%, which can theoretically provide an estimated direct savings in fuel of $140,000-$420,000 per aircraft per year. Assuming an average of 2% drag reduction, annual global aviation fuel savings would reach 1.95 trillion dollars.

The substrate on which the film assemblies are applied can be made of any suitable material, which is generally dictated by the application (e.g., aerospace, watercraft or motor vehicles). For example, the substrate may be made of a material such as aluminum, stainless steel, titanium, metal alloys, composite materials, or polymeric materials. In particular, the substrate may be the surface of a vehicle, e.g., an aircraft, watercraft or automobile.

By applying the coating (A) 130 according to embodiments of the present invention on the film 120, the resulting film assemblies have chemical and physical properties that make them better able to stand up to the harsh environmental conditions encountered during flight or vehicle operation. In particular, the coating (A) applied over the textured film provides a layer of protection for the film. Consequently, the film assemblies according to embodiments of the present invention remain serviceable for longer periods of time, for example from about 4 to about 7 years, which is a typical time period between routine maintenance and repainting of aircraft. However, over time, the coating/film assembly may eventually degrade due to continued exposure to harsh environmental conditions, and may eventually need to be removed and replaced. Accordingly, in some embodiments of the present invention, as discussed above, the coating/film assembly is permeable to organic solvents. As such, removal of the degraded assembly can be easily accomplished by exposing it to such an organic solvent, e.g., a paint stripper. Any suitable organic paint stripper can be used to remove the coating/film assembly, e.g., chlorinated solvents or environmental strippers. The ability to be removed using conventional paint strippers makes the coating/film assembly strippable, which is a unique feature that has not previously been achieved for microstructured films. Removal (or stripping) of the film assembly can be achieved by simply spraying the paint stripper over the surface of the film assembly, letting the paint stripper soak through the assembly, and then peeling the film assembly off the substrate.

According to some alternative embodiments of the invention, the coating formulation can be applied directly on a microstructured substrate, as shown in FIG. 2c rather than on a textured film that is applied to the substrate. In particular, the substrate may be the surface of a vehicle, e.g., an aircraft, watercraft or automobile which itself is textured. As shown in FIG. 2c, which is a cross-sectional view of an exemplary embodiment in which the coating is applied on a substrate, a coating (A) 202 is directly applied on a textured substrate 201. As can be seen in FIG. 2c, the coating (A) faithfully mimics the pattern of the textured substrate.

The textured substrate 201 can be made of any suitable material, which is generally dictated by the application (e.g., aerospace, watercraft or motor vehicles). For example, the substrate may be made of a material such as aluminum, stainless steel, titanium, metal alloys, composite materials, or polymeric materials. In particular, the substrate may be the surface of a vehicle, e.g., an aircraft, watercraft or automobile. The microstructures in the substrate are the same as the microstructures described above with respect to the film 120, and can be a riblet structure, a sawtooth pattern, a scalloped pattern, a blade pattern or a combination thereof. FIGS. 3b and 3c are perspective profile views of two exemplary riblet patterns (discussed above with respect to the film embodiments).

The coating formulation is as described above with respect to the coating (A) 130, and can be applied on the microstructured substrate using any suitable coating methods, such as spray coating, gravure coating, die coating, dip coating, or printing. Also, as described above with reference to FIGS. 2a and 2b, the coating (A) 202 may include one or more of a pretreatment layer 240, a primer layer 250 and a coating layer 230. Additionally, in some embodiments, the pretreatment layer 240 may be omitted and the primer layer 250 may be coated directly on the substrate 210.

When coated directly on a textured substrate 201, the coating (A) 202 must also have the proper rheology (i.e., flow and leveling characteristics) such that the textured profile of the substrate will read through to the surface of the coating (A) after cure. Suitable coating formulations include those discussed above with respect to the coating 130 on the film 120.

According to some alternative embodiments, as shown in FIG. 2d, a laminate 300 includes a film 320, a coating (A) 330 on the film, and an adhesive 335 on the side of the film 320 that is opposite to the coating. The adhesive may be a pressure sensitive adhesive, a permanent adhesive, or any suitable bonding material. When a pressure sensitive adhesive is used, the film assembly may further include a release liner 345 to temporarily protect the adhesive surface. In such a case, the laminate may be provided in roll form, ready for application to a substrate. In particular, the laminate 300 may include the film 320, the coating (A) 330 on the film, the adhesive 335 on an opposite surface of the film, and the release liner 345 on the adhesive. Such a laminate may be used to cover smaller areas of the substrate, or to cover an entire surface of the substrate. However, as applying the laminate 300 as the drag reducing surface may result in small areas at the edges of the laminate where there is no coating, further coating may be applied to these areas after application of the laminate. For example, further coating can be applied at the edges of adjacent laminate sheets to ensure a continuous coating on the substrate.

The following Example is provided for illustrative purpose only, and does not limit the scope of the present invention.

### EXAMPLE 1

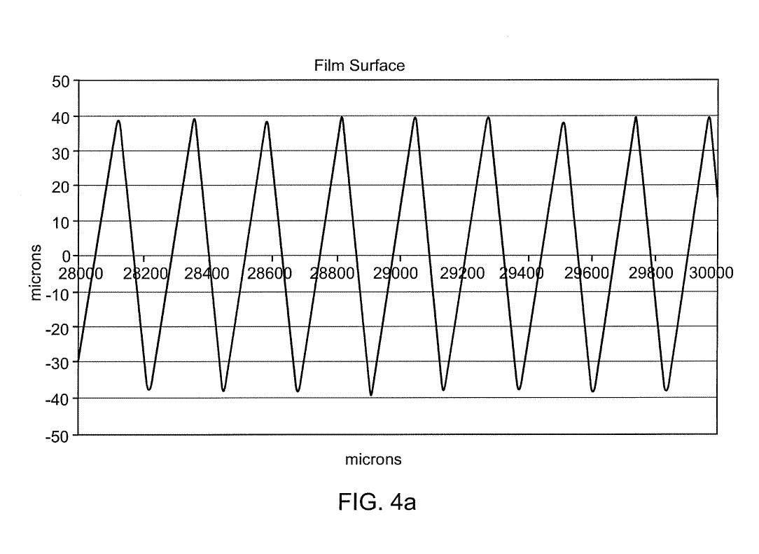

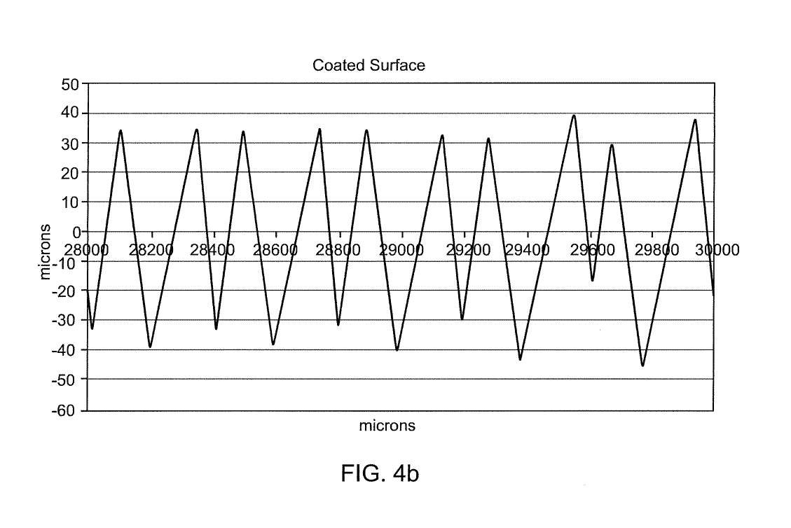

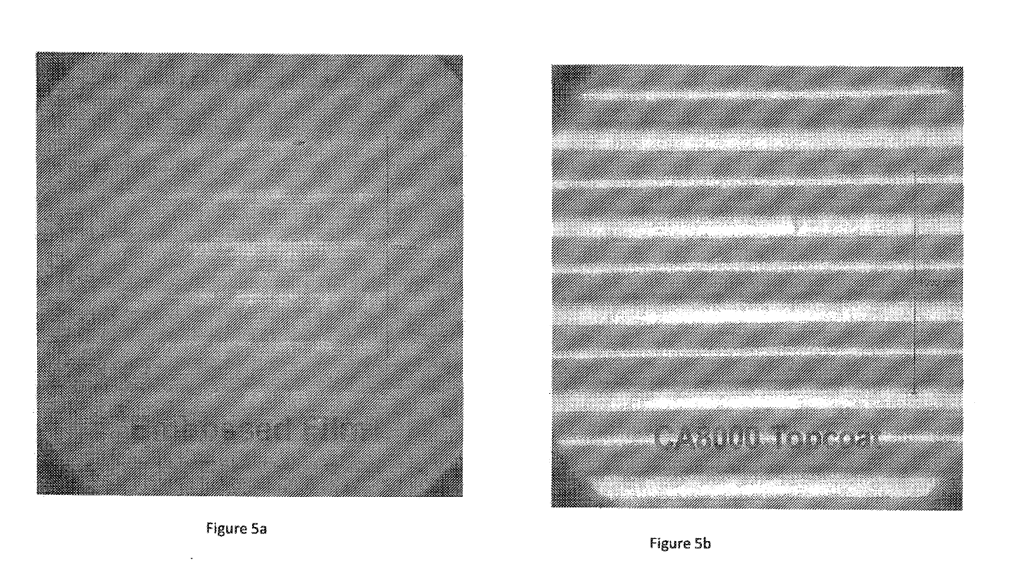

ULTRACAST® having a riblet structure with riblets having an average peak height of 75 microns, and an average spacing between peaks of 150 microns, (manufactured by Sappi-Warren Release Papers in Westbrook, Me.) was coated with Desothane™ HS Buffable Polyurethane Topcoat CA 8800 series (from PPG Industries, Inc.) having a viscosity of 20 seconds as measured using a #2 Zahn cup. The Desothane™ was spray coated on the ULTRACAST® film and cured by near infrared radiation (NIR). The coating thickness was 25 microns. FIG. 4a is a graphical representation of the surface topography of the ULTRACAST® film before being coated, and FIG. 4b is a graphical representation of the topography of the ULTRACAST® film after being coated. FIG. 5a is a photograph of the ULTRACAST® film before being coated with the Desothane™ HS Polyurethane Topcoats/CA 8000, and FIG. 5b is a photograph of the ULTRACAST® film after being coated. As can be seen in FIGS. 4a, 4b, 5a and 5b, the coating applied over the ULTRACAST® film successfully telegraphed the texture of the film. The film surface had an average peak to valley distance of about 78 microns, and an average peak to peak spacing of about 230 microns. The coated film telegraphed the texture of the underlying film through to the coating surface. The coated film showed an averaged peak to valley distance of about 67 microns, and an average peak to peak spacing of about 200 microns.

### EXAMPLE 2

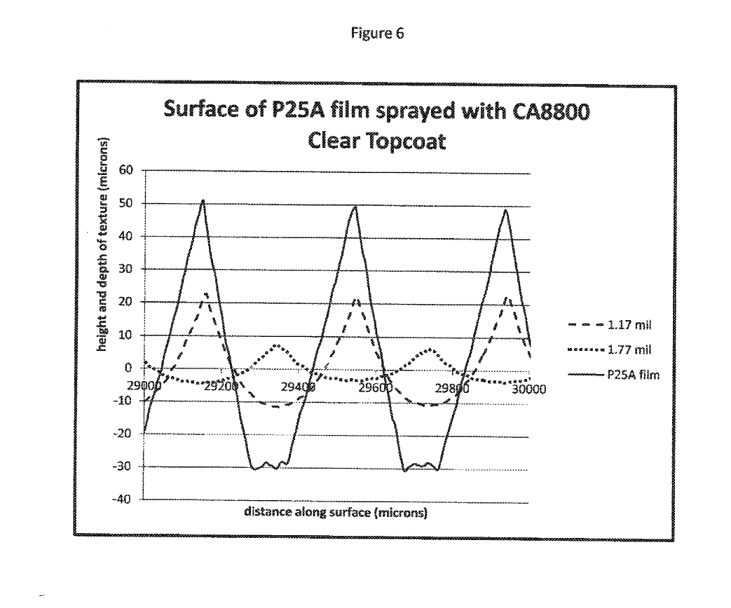

ULTRACAST® having a riblet structure with riblets having an average peak height of 75 microns, and an average spacing between peaks of 150 microns, (manufactured by Sappi-Warren Release Papers in Westbrook, Me.) was coated with Desothane™ HS Buffable Clear Topcoat 8800/B900 series (from PPG Industries, Inc.) having a viscosity of 17 seconds as measured with a #2 Zahn cup. The Desothane™ was spray coated on the ULTRACAST® film and cured by near infrared radiation (NIR). FIG. 6 is a graphical representation of the surface topography of the ULTRACAST® film before being coated (solid line), and after being coated at two different film thicknesses, 1.17 mil (dashed line) and 1.77 mil (dotted lined). As can be seen in FIG. 6, the coating applied over the ULTRACAST® film successfully telegraphed the texture of the film. The ability of the coating to telegraph the texture was dependent of the applied coating film thickness. The film surface had an average peak to valley distance of about 78 microns, and an average peak to peak spacing of about 230 microns. At an applied coating thickness of 1.17 mil, the coating telegraphed the texture of the underlying film through to the coating surface, exhibiting an average peak to value distance of about 33 microns and an average peak to peak spacing of 230 microns. At an applied coating thickness of 1.77 mil, the coating telegraphed the texture of the underlying film through to the coating surface, exhibiting an average peak to value distance of about 13 microns and an average peak to peak spacing of 230 microns.

### EXAMPLE 3

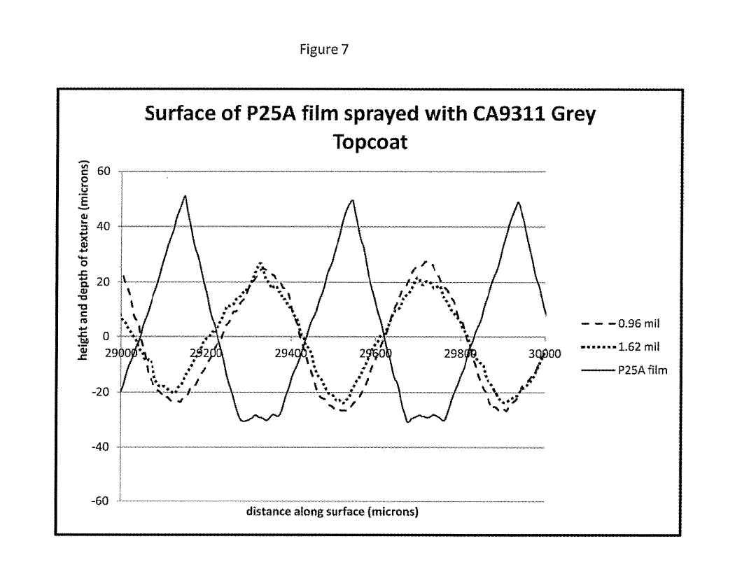

ULTRACAST® having a riblet structure with riblets having an average peak height of 75 microns, and an average spacing between peaks of 150 microns, (manufactured by Sappi-Warren Release Papers in Westbrook, Me.) was coated with Desothane™ HS Advanced Performance Coating CA 9311 series Flat (from PPG Industries, Inc.) having a viscosity of 30 seconds as measured with a #2 Ford cup. The Desothane™ was spray coated on the ULTRACAST® film and cured by near infrared radiation (NIR). FIG. 7 is a graphical representation of the surface topography of the ULTRACAST® film before being coated (solid line), and after being coated at two different film thicknesses, 0.96 mil (dashed line) and 1.62 mil (dotted lined). As can be seen in FIG. 7, the coating applied over the ULTRACAST® film successfully telegraphed the texture of the film. The ability of the coating to telegraph the texture was dependent of the applied coating film thickness. The film surface had an average peak to valley distance of about 78 microns, and an average peak to peak spacing of about 230 microns. At an applied coating thickness of 0.96 mil, the coating telegraphed the texture of the underlying film through to the coating surface, exhibiting an average peak to value distance of about 46 microns and an average peak to peak spacing of 230 microns. At an applied coating thickness of 1.62 mil, the coating telegraphed the texture of the underlying film through to the coating surface, exhibiting an average peak to value distance of about 44 microns and an average peak to peak spacing of 230 microns.

While certain exemplary embodiments of the present invention have been illustrated and described, it is understood by those of ordinary skill in the art that certain modifications and changes can be made to the described embodiments without departing from the spirit and scope of the present invention.

We claim:

1. A method of removing a laminate from a substrate comprising the steps of:
(a) exposing an external surface of the laminate to an organic solvent, wherein the laminate comprises a film having a texture on a first surface and affixed to at least a portion of the substrate by an adhesive on a second surface, and a coating on at least a portion of the first surface of the film that telegraphs the texture to the external surface of the laminate;
(b) letting the organic solvent soak through the laminate to contact the adhesive; and
(c) peeling the laminate off the substrate.

2. The method of claim 1, wherein exposing the external surface of the laminate to the organic solvent is by spraying the organic solvent onto the external surface of the laminate.

3. The method of claim 1, wherein the organic solvent is a chlorinated solvent.

4. The method of claim 1, wherein the organic solvent is an environmental paint stripper.

5. The method of claim 1, wherein the film comprises a film substrate and a film coating on the film substrate.

6. The method of claim 5, wherein the film substrate comprises a fluoropolymer, a polyetheretherketone (PEEK), a polyester, a polyphenylsulfone, a polyolefin, a polycarbonate, and/or an acrylic film.

7. The method of claim 6, wherein the film substrate comprises a fluoropolymer.

8. The method of claim 6, wherein the film substrate comprises a polyolefin.

9. The method of claim 6, wherein the film substrate comprises a polyphenylsulfone.

10. The method of claim 1, wherein the substrate is an aircraft, an airplane, an automobile, a ship, a boat, a wind turbine, a water craft, an airfoil, or a rudder.

11. The method of claim 1, wherein the coating is a polyurethane based coating.

12. The method of claim 1, wherein the coating comprises a primer and a topcoat.

13. The method of claim 12, wherein the primer is an epoxy-amine primer and the topcoat is a polyurethane based coating.

14. The method of claim 1, wherein the coating is formed from a coating composition having a viscosity of about 5 to about 60 seconds as measured with a #4 Ford cup.

15. The method of claim 1, wherein the thickness of the coating is from 5 μm to 500 μm.

16. The method of claim 1, wherein the texture includes a riblet structure, a sawtooth pattern, a scalloped pattern, a blade pattern, or a combination thereof.
